(19) United States
(12) Patent Application Publication
(10) Pub. No.: US 2019/0335714 A1
(43) Pub. Date: Nov. 7, 2019

(54) SOUND GENERATING PET TOY

(71) Applicant: Radio Systems Corporation, Knoxville, TN (US)

(72) Inventors: Amanda Sweetnam, Knoxville, TN (US); Krista Nixon, Knoxville, TN (US); Liu Feng, Knoxville, TN (US); Jacky Li, Knoxville, TN (US)

(21) Appl. No.: 16/404,083

(22) Filed: May 6, 2019

Related U.S. Application Data
(60) Provisional application No. 62/667,832, filed on May 7, 2018.

(51) Int. Cl. A01K 15/02

(52) U.S. Cl. CPC A01K 15/025

(57) ABSTRACT

A sound generating pet toy is provided which includes two similarly configured pet toy components. Each pet toy component has an exterior housing and an electronics module. The electronics module includes and electronics circuit having d.c. batteries, a microprocessor which includes a wireless transceiver component, a timer, a speaker, a push button on/off switch, and a high sensitivity vibration switch sensor. The microprocessor is electrically coupled to and powered by the batteries. The microprocessors are programmed to emit a sound upon activation from a first pet toy components, and thereafter to switch the generation of the sound to the second pet toy component upon sensing movement of the first pet toy component, this switching occurring back and forth between the two pet toy components as long as movement is sensed.

### CROSS REFERENCE TO RELATED APPLICATIONS

This application claims the benefit of U.S. Provisional Patent Application No. 62/667,832 filed May 7, 2018 and entitled “Sound Generating Pet Toy”, and is incorporated herein by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### Field of the Invention

The present inventive concept relates to the field of pet toys. More particularly, the invention relates to a pet toy which generates sounds to enhance play.

### Technology in the Field of the Invention

Pet owners have used simple balls as a convenient and easy to use pet toy. The owner throws the ball so that the dog or cat may chase it and return it to the owner. However, this use of a ball requires the presence of a person to throw the ball in order to entertain the pet. The task of throwing the ball over and over again may become quite tedious and tiring.

Many other toys exists which also entertain a dog through similar interaction with a person, such as tug toys. Here, the dog bites down on one portion of the toy while the person holds an opposite end. A game of “tug” ensues wherein the dog tries to pull the toy from the grasp of the person. Again, these toys require a person's interaction to make them entertaining.

With many such pet toys, the pet may want to continue to play long after a person wishes to stop. Thus, a need exists for a toy which entertains a pet without interaction from a person.

### BRIEF SUMMARY OF THE INVENTION

A sound generating pet toy comprises a first pet toy component having a first exterior housing and a first electronics module including a first battery source, a first microprocessor electrically coupled to the first battery source, a first wireless transceiver coupled to the first microprocessor, a first speaker electrically coupled to the first microprocessor, and a first motion sensitive sensor electrically coupled to the first microprocessor. A second pet toy component has a second exterior housing and a second electronics module including a second battery source, a second microprocessor electrically coupled to the second battery source, a second wireless transceiver coupled to the second microprocessor, a second speaker electrically coupled to the second microprocessor, and a second motion sensitive sensor electrically coupled to the first microprocessor. The first and second microprocessors is in wireless communication with each other through the first and second transceivers. The first microprocessor is programmed to commence a first sound generating signal to the first speaker and subsequently stopping the first sound generating signal to the first speaker upon receiving a first motion signal from the first motion sensitive sensor. The first transceiver wirelessly communicates to the second transceiver a first activation signal upon the first microprocessor receiving the first motion signal from the first motion sensitive sensor, and the second microprocessor is programmed to commence a second sound generating signal to the second speaker upon receiving the first activation signal from the first transceiver to the second transceiver and subsequently stopping the second sound generating signal to the second speaker upon receiving a second motion signal from the second motion sensitive sensor. The second transceiver wirelessly communicates to the first transceiver a second activation signal upon the second microprocessor receiving the second motion signal from the second motion sensitive sensor.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of a sound generating pet toy embodying principles of the invention in a preferred form.

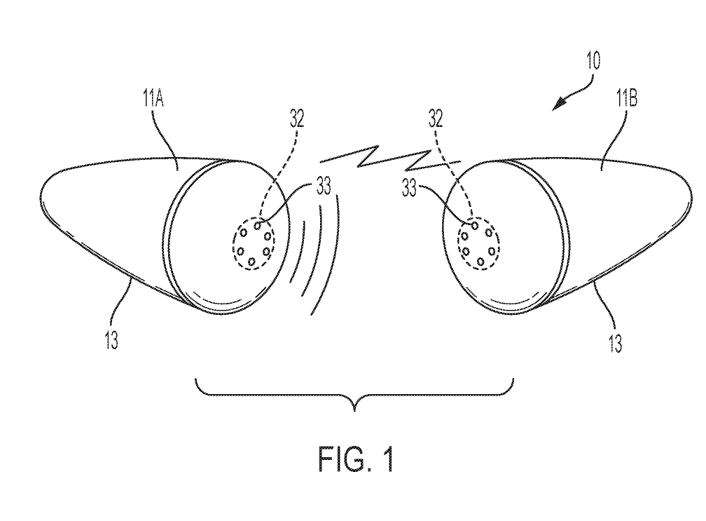

FIG. 2 is an exploded view of a portion of the sound generating pet toy of FIG. 1.

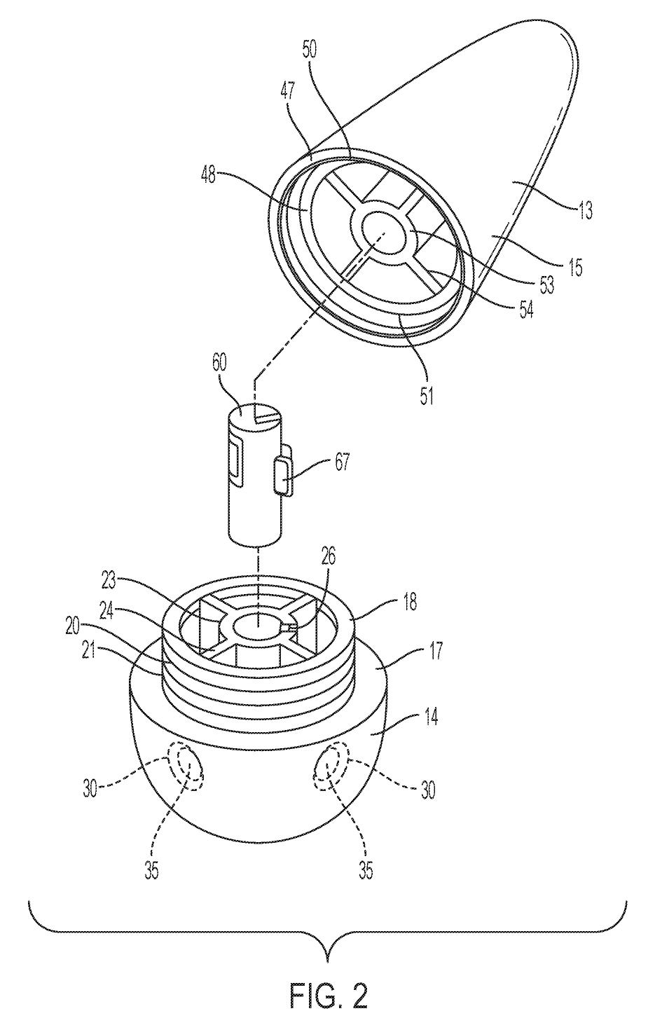

FIG. 3 is a cross-sectional view schematically illustrating the sound generating pet toy of FIG. 1.

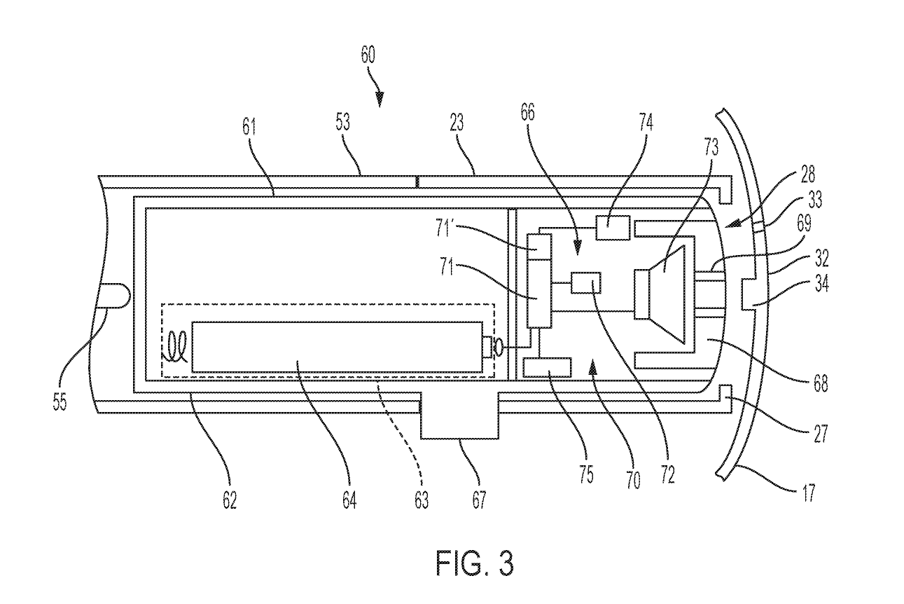

### DETAILED DESCRIPTION OF CERTAIN EMBODIMENTS

Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Description of Selected Specific Embodiments

With reference next to the drawings, there is a shown a sound generating pet toy 10 in a preferred form of the present invention, referenced hereinafter as pet toy 10. The pet toy 10 is comprised of two similarly configured pet toy components, referenced hereinafter singularly as pet toy component 11A and pet toy component 11B.

Each pet toy component 11A and 11B has a generally egg shaped, exterior housing 13. The exterior housing 13 consists of a first portion 14 and a second portion 15 releasably coupled to the first portion 14. The exterior shape may be of any shape, such as an oval, round, cylinder, pill-shape, or other non-rounded shapes. Thus, preferably the exterior housing 13 has a rounded exterior surface to enable the rolling of the pet toy components upon a floor or similar flat surface.

The first portion 14 includes a first outer shell 17 and a first interior coupling member 18. The first interior coupling member 18 has a first outer wall 20 that conforms to the shape of the interior surface of the first outer shell 17. A portion of the outer wall 20 extends beyond the first outer shell 17 to form a generally cylindrical, exterior threaded mounting flange 21. The first interior coupling member 18 also has a central, concentrically positioned, cylindrical, first electronics housing 23. Four radially extending supports 24 extend between the first electronics housing 23 and the first outer wall 20.

The first electronics housing 23 includes a slot or keyway 26. The bottom or end of the first electronics housing 23 has an annular stop or interior flange 27 which defines an opening 28 extending through the first interior coupling member 18. The first electronics housing 23 also has four coupling holes 30 extending there through, each of which is positioned between two adjacent supports 24.

The first outer shell 17 has an end portion 32 which is of a soft, pliable or flexible material to enable the pet to grasp it easier with its teeth. The end portion 32 has an annular array of speaker holes 33 which are aligned with and in communication with the opening 28 of the first electronics housing 23. The end portion 32 also includes a central, inwardly extending button or detent 34. The first outer shell 17 also includes four detents or holding tabs 35 which are configured to receive and be in register with the four coupling holes 30 of the first electronics housing 23 to aid in securing the first outer shell 17 to the first interior coupling member 18.

The second portion 15 includes a second outer shell 47 and a second interior coupling member 48. The second interior coupling member 48 has a second outer wall 50 that conforms to the shape of the interior surface of the second outer shell 47. A portion of the second outer wall 50 forms a generally cylindrical, interior threaded receiving flange 51 which is configured to threadably mesh with the exterior threaded mounting flange 21 of the first interior coupling member 48 in order to releasably couple the first and second portions 14 and 15 together. The second interior coupling member 48 also has a central, concentrically positioned, cylindrical, second electronics housing 53. Four radially extending supports 54 extend between the second electronics housing 53 and the second outer wall 50. The second electronics housing 53 has inwardly extending stops in the form or ribs 55.

Each pet toy component 11A and 11B also has an electronics module 60 removably coupled to and residing within the first electronics housing 23 and second electronics housing 53 between the interior flange 27 and ribs 55. The electronics module 60 includes a generally cylindrical module housing 61. The module housing 61 has a peripheral wall 62 which defines a series of battery receiving areas or ports 63 in which are mounted conventional d.c. batteries (battery power source) 64, and an electronics cavity 66. A pair of alignment flanges 67 extend radially from the peripheral wall 62. The alignment flanges 67 are configured to be indexed or received within the keyway 26 of the first electronics housing 23 to maintain the position of the electronics module 60 relative to the first electronics housing 23. The electronics module 60 has an end wall 68 which is inwardly movable or depressible with respect to the peripheral wall 62. The end wall 68 has a series of speaker holes 69 there through.

The electronics module 60 includes an electronics circuit 70 positioned within the electronics cavity 66. The electronic circuit 70 includes a microprocessor 71 which includes a wireless transceiver component or transceiver 71′, such as a 2.4 GHz transceiver with embedded microcontroller. The transceiver 71′ of each pet toy component 11A or 11B communicates with the transceiver 71′ of the other pet toy component 11A or 11B. The microprocessor 71 is coupled to a timer 72, such as a crystal oscillator timer, a speaker 73, a push button on/off switch 74, and a high sensitivity motion or vibration switch sensor 75, such as a conventionally known SW-18010P, collectively referenced herein as vibration switch sensor. The microprocessor 71 is electrically coupled to and powered by the batteries 64.

The speaker 73 is positioned within the cavity 66 behind the end wall 68 so that sound emanating from the speaker 73 passes through the end wall speaker holes 69, through opening 28, and through the outer shell speaker holes 33, so that it can be heard by the pet.

The push button on/off switch 74 is also positioned within the cavity behind the end wall 68 so that the inward movement of the end wall 68, through inward movement of the end portion 32 and button 34, actuates the push button on/off switch 74 to its on or off position. The actuation of the push button on/off switch 74 energizes or de-energizes the microprocessor 71, and thus operation of the pet toy components 11A and 11B.

In use, a person actives the sound generating pet toy 100 by pressing upon the end portion 32 of the first outer shells 17 of each pet toy component 11A and 11B. The inward movement of the end portion 32 causes the underlying button 34 to actuate the on/off switch 74 of each pet toy component 11A and 11B. This activation causes the microprocessors 71 to communicate or sync with each other, the synching of which is indicated by an electronic impulse to the speakers 23 to create an activation sound, such as a beep.

Once the pet toy components 11A and 11B are synced the pet toy components 11A and 11B are placed on the floor is separate locations, i.e., they are separated from each other. One of the two pet toy components, for illustrative purposes herein pet toy component 11A, will begin to emit a play sound through the microprocessor 71 sending an electronic signal or impulse (first sound generating signal) to the speaker 73. The play sound may be any sound which is intended to engage play with a pet, such as a squeaking, chirping, beeping sound.

The play sound emanating from the first pet toy component 11A induces the pet into engaging with the first pet toy component 11A by either pawing at the toy or grasping it with its mouth. As the pet initiates contact with the first pet toy component 11A and thereby causes it to move, the vibration sensitive switch sensor 75 senses the movement and relays an electronic signal (first motion signal) to the microprocessor 71. The microprocessor and transceiver 71′ of the first pet component 11A wirelessly relays a signal (first activation signal) to the microprocessor and transceiver 71′ of the other or second pet toy component 11B. The microprocessor 71 of the first pet toy component 11A also stops sending an electronic impulse to the speaker 23 so that the first pet toy component 11A stops producing the play sound.

The receipt of the wireless signal (first activation signal) by the microprocessor 71 of the second pet toy component 11B causes the microprocessor 71 to start generating an electronic signal (second sound generating signal) to its corresponding speaker 73 in order to generate a play sound. In other words, the movement of the first pet toy component 11A causes it to stop generating a play sound while causing the second pet toy component 11B to start generating a play sound, i.e., the sound alternates between the first and second pet toy components.

This alternating of the starting and stopping of the pet toy components 11A and 11B to generate play sounds back and forth may continue so long as the pet continues to play with the pet toy components. For example, pet toy component 11A starts generating a sound, the pet grasps pet toy component 11A wherein the sound stops and the sound starts emanating from pet toy component 11B. When the pet now drops first pet toy component 11A and grasps second pet toy component 11B, the sound from the pet toy component 11B stops and the sound now starts emanating from the first pet toy component 11A again. This back and forth sounding continues so long as the pet is engaging the sounding pet toy components 11A and 11B.

Each microprocessor 71 is programmed to send the electronic signal to the speaker 73 for a designated time period, for example 10 seconds. If the pet has not engaged the active pet toy component by the end of the designated period, the microprocessor 71 will stop generating the electronic signal (sound generating signal) to the speaker 23 for a second designated time period, for example, it will stay silent for 5 minutes. If the pet engages or moves either pet toy component 11A or 11B during the silent second designated time period, the opposite or other pet toy component will start generating a sound again. If neither pet toy component 11A or 11B has been active for a extending time period, for example one hour, the microprocessors 71 of both pet toy components will automatically turn off to conserve battery life. Alternatively, a person may turn off the pet toy by depressing the end portions 32 so as to actuate the on/off switches 74 of each pet toy component 11A and 11B.

It should be understood that the activation of sound generated by another toy separate from the toy the pet is presently engaging causes the pet to move from one toy to another. This constant back and forth playing between two separate toys prevents pet boredom and creates an extended play or engagement with the pet. This play continues without the need for human participation.

A sound generating pet toy 10 of an embodiment comprises a first pet toy component 11A having a first exterior housing 13 and a first electronics module 60, the first electronics module 60 including a first battery source 64, a first microprocessor 71 electrically coupled to the first battery source, a first wireless transceiver 71′ coupled to the first microprocessor, a first speaker 73 electrically coupled to the first microprocessor, and a first motion sensitive sensor 75 electrically coupled to the first microprocessor. The sound generating pet toy also has a second pet toy component 11B separate and apart from the first pet toy component, the second pet toy component 11B having a second exterior housing 13 and a second electronics module 60, the second electronics module 60 including a second battery source 64, a second microprocessor 71 electrically coupled to the second battery source, a second wireless transceiver 71′ coupled to the second microprocessor, a second speaker 73 electrically coupled to the second microprocessor, and a second motion sensitive sensor 75 electrically coupled to the first microprocessor. The first and second microprocessors 71 are in wireless communication with each other through the first and second transceivers, the first microprocessor 71 being programmed to commence a first sound generating signal to the first speaker 73 and subsequently stopping the first sound generating signal to the first speaker 73 upon receiving a first motion signal from the first motion sensitive sensor 75, the first transceiver 71′ wirelessly communicating to the second transceiver 71′ a first activation signal upon the first microprocessor 71 receiving the first motion signal from the first motion sensitive sensor 75. The second microprocessor 71 is programmed to commence a second sound generating signal to the second speaker 73 upon receiving the first activation signal from the first transceiver 71′ to the second transceiver 71′ and subsequently stopping the second sound generating signal to the second speaker 73 upon receiving a second motion signal from the second motion sensitive sensor 73, the second transceiver 71′ wirelessly communicating to the first transceiver 71′ a second activation signal upon the second microprocessor 71′ receiving the second motion signal from the second motion sensitive sensor 75.

The sound generating pet toy 10 also comprises the first electronics module 60 further including a first timer 72 coupled to the first microprocessor 71. The second electronics module 60 further includes a second timer 72 coupled to the second microprocessor 71. The first microprocessor 71 is programmed to send the first sound generating signal to the first speaker 73 for a first designated time period. The second microprocessor 71 is programmed to send the second sound generating signal to the second speaker 73 for a second designated time period.

The sound generating pet toy 10 also comprises the first pet toy component 11A including a first interior coupling member 18 mounted within the first exterior housing 13, the first interior coupling member 18 having a first outer wall 20, a first electronics housing 23 receiving the first electronics module 60, and a plurality of first supports 24 extending between the first outer wall 20 and the first electronics housing 23.

The sound generating pet toy 10 also comprises the second pet toy component 11B including a second interior coupling member 18 mounted within the second exterior housing 13, the second interior coupling member 18 having a second outer wall 20, a second electronics housing 23 receiving the second electronics module 60, and a plurality of second supports 24 extending between the second outer wall 20 and the second electronics housing 23.

The sound generating pet toy 10 also comprises the first electronics housing 23 including a slot 26 and wherein the first electronics module 60 includes a flange 67 configured to be received within the slot to prevent rotational movement therebetween.

The sound generating pet toy 10 also comprises the exterior housing 13 having a first portion 14 removably coupled to a second portion 15.

A sound generating pet toy 10 of an embodiment comprises a first pet toy component 11A having a first exterior housing 13, a first power source 64, a first microprocessor 71 electrically coupled to the first power source 64, a first wireless transceiver 71′ coupled to the first microprocessor 71, a first speaker 73 electrically coupled to the first microprocessor 71, and a first motion sensor 75 electrically coupled to the first microprocessor 71. The sound generating pet toy 10 also has a second pet toy component 11B separate and apart from the first pet toy component 11A, the second pet toy component 11B having a second exterior housing 13, a second power source 64, a second microprocessor 71 electrically coupled to the second power source 64, a second wireless transceiver 71′ coupled to the second microprocessor 71, a second speaker 74 electrically coupled to the second microprocessor 71, and a second motion sensor 75 electrically coupled to the first microprocessor 71. The first and second microprocessors 71 are in wireless communication with each other through the first and second transceivers 71′ to alternate the production of an audible sound from the first and second pet toy components 11A and 11B.

The sound generating pet toy 10 also comprises the first and second exterior housings 13 having a round exterior surface whereby the round exterior surface allows for rolling of the first pet toy component.

The sound generating pet toy 10 also comprises the first and second exterior housings 13 having a pliable exterior shell 47 whereby the pliable exterior shell 47 allows the pet to grasp the first pet toy component.

A sound generating pet toy 10 of an embodiment comprises a pair of pet toy components 11A and 11B wherein each pet toy component includes an exterior housing 13, a power source 63, and an electronic module 60 electrically coupled to the power source. The pair of pet toy components are in wireless communication with each other so that a first pet toy component of the pair of pet toy components generates a sound while a second pet toy component of the pair of pet toy components is silent, and the first pet toy component 11A of the pair of pet toy components is silent while the second pet toy component 11B generates a sound. The alternating generation of sounds produced by the first and second pet toy components enhances play for a pet.

It will be appreciated that the inventions are susceptible to modification, variation and change without departing from the spirit thereof.

1. A sound generating pet toy comprising:
a first pet toy component having a first exterior housing and a first electronics module, said first electronics module including a first battery source, a first microprocessor electrically coupled to said first battery source, a first wireless transceiver coupled to said first microprocessor, a first speaker electrically coupled to said first microprocessor, and a first motion sensitive sensor electrically coupled to said first microprocessor;
a second pet toy component separate and apart from said first pet toy component, said second pet toy component having a second exterior housing and a second electronics module, said second electronics module including a second battery source, a second microprocessor electrically coupled to said second battery source, a second wireless transceiver coupled to said second microprocessor, a second speaker electrically coupled to said second microprocessor, and a second motion sensitive sensor electrically coupled to said first microprocessor;
said first and second microprocessors being in wireless communication with each other through said first and second transceivers;
said first microprocessor being programmed to commence a first sound generating signal to said first speaker and subsequently stopping said first sound generating signal to said first speaker upon receiving a first motion signal from said first motion sensitive sensor, said first transceiver wirelessly communicating to said second transceiver a first activation signal upon said first microprocessor receiving said first motion signal from said first motion sensitive sensor, and
said second microprocessor being programmed to commence a second sound generating signal to said second speaker upon receiving said first activation signal from said first transceiver to said second transceiver and subsequently stopping said second sound generating signal to said second speaker upon receiving a second motion signal from said second motion sensitive sensor, said second transceiver wirelessly communicating to said first transceiver a second activation signal upon said second microprocessor receiving said second motion signal from said second motion sensitive sensor.

2. The sound generating pet toy of claim 1 wherein said first electronics module further includes a first timer coupled to said first microprocessor, and wherein said second electronics module further includes a second timer coupled to said second microprocessor,
and wherein said first microprocessor is programmed to send said first sound generating signal to said first speaker for a first designated time period,
and wherein said second microprocessor is programmed to send said second sound generating signal to said second speaker for a second designated time period.

3. The sound generating pet toy of claim 1 wherein said first pet toy component includes a first interior coupling member mounted within said first exterior housing, said first interior coupling member having a first outer wall, a first electronics housing receiving said first electronics module, and a plurality of first supports extending between said first outer wall and said first electronics housing.

4. The sound generating pet toy of claim 3 wherein said second pet toy component includes a second interior coupling member mounted within said second exterior housing, said second interior coupling member having a second outer wall, a second electronics housing receiving said second electronics module, and a plurality of second supports extending between said second outer wall and said second electronics housing.

5. The sound generating pet toy of claim 3 wherein said first electronics housing includes a slot and wherein said first electronics module includes a flange configured to be received within said slot to prevent rotational movement therebetween.

6. The sound generating pet toy of claim 1 wherein said exterior housing is comprised of a first portion removably coupled to a second portion.

7. A sound generating pet toy comprising:
a first pet toy component having a first exterior housing, a first power source, a first microprocessor electrically coupled to said first power source, a first wireless transceiver coupled to said first microprocessor, a first speaker electrically coupled to said first microprocessor, and a first motion sensor electrically coupled to said first microprocessor;
a second pet toy component separate and apart from said first pet toy component, said second pet toy component having a second exterior housing, a second power source, a second microprocessor electrically coupled to said second power source, a second wireless transceiver coupled to said second microprocessor, a second speaker electrically coupled to said second microprocessor, and a second motion sensor electrically coupled to said first microprocessor;
said first and second microprocessors being in wireless communication with each other through said first and second transceivers to alternate the production of an audible sound from said first and second pet toy components.

8. The sound generating pet toy of claim 7 wherein said first microprocessor is programmed to commence a first sound generating signal to said first speaker and subsequently stopping said first sound generating signal to said first speaker upon receiving a first motion signal from said first motion sensor, said first transceiver wirelessly communicating to said second transceiver a first activation signal upon said first microprocessor receiving said first motion signal from said first motion sensor, and said second microprocessor is programmed to commence a second sound generating signal to said second speaker upon receiving said first activation signal from said first transceiver to said second transceiver and subsequently stopping said second sound generating signal to said second speaker upon receiving a second motion signal from said second motion sensor, said second transceiver wirelessly communicating to said first transceiver a second activation signal upon said second microprocessor receiving said second motion signal from said second motion sensor.

9. The sound generating pet toy of claim 8 wherein said first pet toy component includes a first timer coupled to said first microprocessor, and wherein said second pet toy component includes a second timer coupled to said second microprocessor,
and wherein said first microprocessor is programmed to send said first sound generating signal to said first speaker for a first designated time period,
and wherein said second microprocessor is programmed to send said second sound generating signal to said second speaker for a second designated time period.

10. The sound generating pet toy of claim 7 wherein said first pet toy component includes a first interior coupling member mounted within said first exterior housing, said first interior coupling member having a first outer wall, a first electronics housing, and a plurality of first supports extending between said first outer wall and said first electronics housing.

11. The sound generating pet toy of claim 10 wherein said second pet toy component includes a second interior coupling member mounted within said second exterior housing, said second interior coupling member having a second outer wall, a second electronics housing, and a plurality of second supports extending between said second outer wall and said second electronics housing.

12. The sound generating pet toy of claim 7 wherein said first exterior housing has a round exterior surface,
whereby the round exterior surface allows for rolling of the first pet toy component.

13. The sound generating pet toy of claim 12 wherein said second exterior housing has a round exterior surface,
whereby the round exterior surface allows for rolling of the second pet toy component.

14. The sound generating pet toy of claim 7 wherein said first exterior housing has a pliable exterior shell,
whereby the pliable exterior shell allows the pet to grasp the first pet toy component.

15. The sound generating pet toy of claim 14 wherein said second exterior housing has a pliable exterior shell,
whereby the pliable exterior shell allows the pet to grasp the first pet toy component.

16. A sound generating pet toy comprising:
a pair of pet toy components wherein each pet toy component includes an exterior housing, a power source, and an electronic module electrically coupled to said power source, said pair of pet toy components being in wireless communication with each other so that a first pet toy component of said pair of pet toy components generates a sound while a second pet toy component of said pair of pet toy components is silent, and said first pet toy component of said pair of pet toy components is silent while the second pet toy component generates a sound,
whereby the alternating generation of sounds produced by the first and second pet toy components enhances play for a pet.

17. The sound generating pet toy of claim 16 wherein said electronic modules of each said pair of pet toy components includes a first battery source, a first microprocessor electrically coupled to said first battery source, a first wireless transceiver coupled to said first microprocessor, a first speaker electrically coupled to said first microprocessor, and a first motion sensitive sensor electrically coupled to said first microprocessor.

18. The sound generating pet toy of claim 17 wherein each said electronics module further includes a timer coupled to said microprocessor.

19. The sound generating pet toy of claim 16 wherein said exterior housing of each said pet toy component has a round exterior surface,
whereby the round exterior surface allows for rolling of the pet toy components.

20. The sound generating pet toy of claim 16 wherein said exterior housing of each said pet toy component has a pliable exterior shell,
whereby the pliable exterior shell allows the pet to grasp the pet toy component.
